(19) United States
(12) Patent Application Publication
(10) Pub. No.: US 2019/0370908 A1
(43) Pub. Date: Dec. 5, 2019

(54) USER INTERFACE FOR NETWORK ENGAGEMENT

(71) Applicant: Microsoft Technology Licensing, LLC, Redmond, WA (US)

(72) Inventors: Ken Soong, Menlo Park, CA (US); Chanh Nguyen, Sunnyvale, CA (US); Yu-Hsin Lin, San Francisco, CA (US); William Lai, Los Altos, CA (US); Yuet Man Vivien Sin, San Francisco, CA (US); Christine Hsueh Chun Chou, San Francisco, CA (US)

(21) Appl. No.: 15/992,781

(22) Filed: May 30, 2018

(51) Int. Cl. G06Q 50/00; G06Q 30/02

(52) U.S. Cl. CPC G06Q 50/01; G06F 3/04842; G06Q 30/0201

(57) ABSTRACT

A system, method, and computer readable medium includes obtaining activities of members of the online social networking system and social graph data of the members and computing an influence score for one of the members by combing an access to content score with an activities score. The access to content score is based on a number of social graph connections of the one of the members with other members and the activities score is based on a number of activities by the member with content items posted to the online social networking system by other members and activities by other members with content items posted by the member. A user interface displays a user interface screen to display the influence score in relation to the member and, in response to a selection, displays an influence score calculation screen including graphical illustrations of the access to content and activities scores.

### TECHNICAL FIELD

The subject matter disclosed herein generally relates to a user interface for facilitating network engagement.

### BACKGROUND

Online networks, such as online social networks, obtain content from various sources, including members and other users of the online network. The content may be formatted and then presented to various members, e.g., on a feed, as special links, popup messages, and the like. How members react to content displayed to them may help drive further engagement by members and users of the online network.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking system, consistent with some examples.

FIG. 2 is a depiction of a user interface screen as provided by a social networking system, in an example embodiment.

FIG. 3 is an influence score screen, in an example embodiment.

FIG. 4 is an influence score calculation screen, in an example embodiment.

FIG. 5 is a graphical illustration of a decaying function 500, in an illustrative example.

FIG. 6 is a flowchart for generating a user interface for user influence, in an example embodiment.

FIG. 7 is a block diagram illustrating components of a machine able to read instructions from a machine-readable medium.

### DETAILED DESCRIPTION

Example methods and systems are directed to user interface for facilitating network engagement. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The extent to which members of an online network drive engagement by other members may be assessed as the members' individual influence, and members that drive relatively large amounts of engagement may colloquially be referred to as “influencers”. An online networking system has been developed that quantifies and displays an influence score for members of the online network. The online network assess influence for a given member according to several metrics of engagement by the member, including the posting of content to the online network, the sharing of content posted by other members or users, the viewing of or commenting on content posted by others, responses from other members to content posted by and actions of the member, and so forth.

The online network may then generate and display a user interface that both illustrates how the influence score is generated and promotes actions on the online network to drive additional engagement by the member. In so doing, the stature and influence of the member on the online network may increase while driving more use of the online network overall. As a consequence, network resources may be more efficiently utilized than may otherwise be the case owing to members directing their activities to those that do not encourage further engagement, thereby underutilizing network resources and/or driving the use of network resources to relatively unproductive uses.

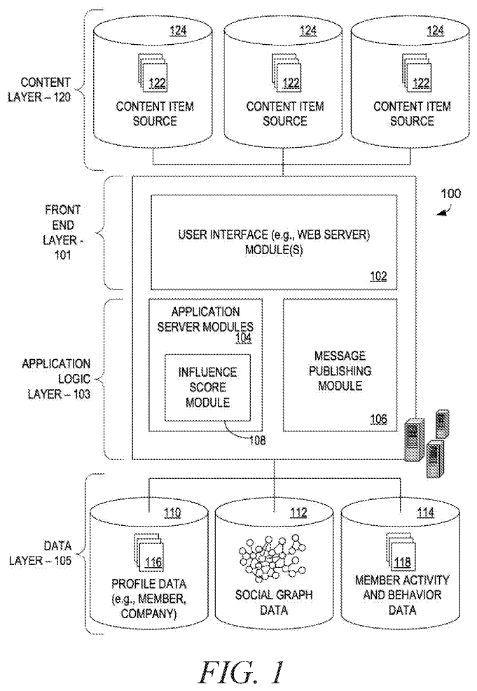

FIG. 1 is a block diagram illustrating various components or functional modules of an online social networking system 100, consistent with some examples. A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network system 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104. In some examples, the social network system 100 includes a content item publishing module 106, such as may be utilized to receive content, such as electronic messages, posts, links, images, videos, and the like, and publish the content to the social network.

One or more of the application server modules 104, the content item publishing module 106, or the social network system 100 generally may include an influence score module 108. As will be disclosed in detail herein, the influence score module 108 may calculate an influence score for a user and prompt the user interface module 102 to display the influence score as well as relevant information related to how the influence score was calculated and how the influence score may be improved. The influence score module 108 may be implemented on a separate server or may be part of a server that provides other portions of the social network system 100. Thus, it is to be understood that while the influence score module 108 is described as an integral component of the online social networking system 100, the principles described herein may be applied without the influence score module 108 being an integral part of the online social networking system or even necessarily utilizing data from a social network if information that would normally be stored in the data layer 105 is available from alternative sources.

As illustrated, the data layer 105 includes, but is not necessarily limited to, several databases 110, 112, 114, such as a database 110 for storing profile data 116, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member Who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

Activities by users of the social network system 100 may be logged as activities 118 in the activity and behavior database 114. Such activities may include search terms, interactions with search results by recruiters, and subsequent engagement between the recruiter and the candidate members who were produced by searches, and so forth. Profile data 116, activities 118, and the social graph of a member may collectively be considered characteristics of the member and may be utilized separately or collectively as disclosed herein.

The data layer 105 collectively may be considered a content item database, in that content items, including but not limited to member profiles 116, may be stored therein. Additionally or alternatively, a content item layer 120 may exist in addition to the data layer 105 or may include the data layer 105, The content item layer 120 may include individual content items 122 stored on individual content item sources 124. The member profiles 116 and the activities 118 may be understood to be content items 122, while the profile database 110, the social graph database 112, and the member activity database 114 may also be understood to be content item sources 124. Content items 122 may further include sponsored content items as well as posts to a news feed, articles or links to websites, images, sounds, event notifications and reminders, recommendations to users of the social network for jobs or entities to follow within the social network, and so forth.

The social network system 100 may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest, With some examples, the social network service may host various job listings providing details of job openings with various organizations.

Although not shown, with some examples, the social network system 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

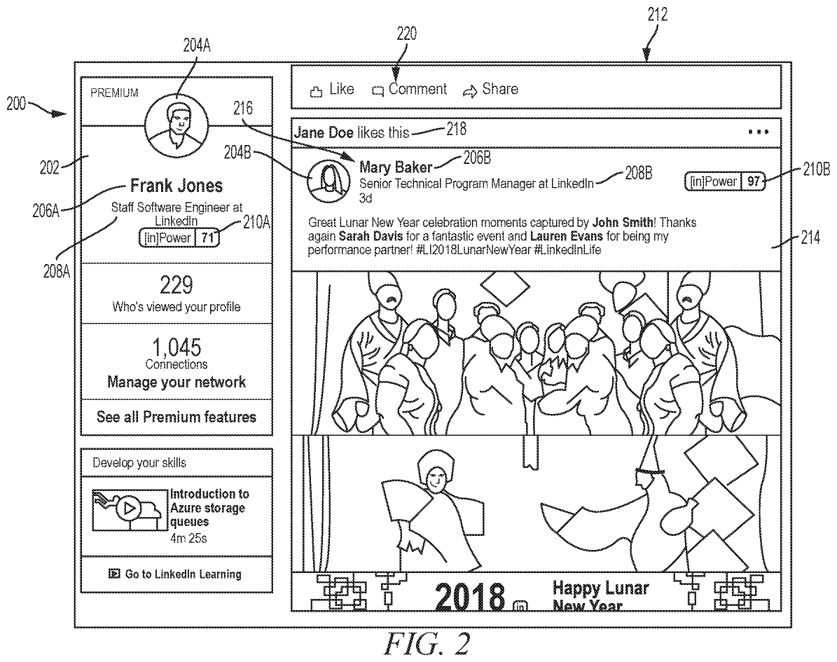

FIG. 2 is a depiction of a user interface screen 200 as provided by the social networking system 100, in an example embodiment. The user interface 200 may be displayed on a user device, such as a personal computer, tablet computer, smartphone, and the like. The user interface 200 includes a member window 202 showing information related to a member of the online social networking system 100 who has logged into the online social networking system 100 via the user interface 200. The member window 202 includes, among the member information, an image 204A, a name 206A, a job description 208A, and an influence score 210A of the member, as obtained from the profile database 110 and generally from the data layer 105. In various examples, the influence score 210A may be or may be displayed as part of an icon, the clicking of which may take the member to an influence score screen, as disclosed herein.

The user interface 200 further includes a feed 212 for displaying content panes 214 derived from content items 122. The content panes 214 include user information 216 from which the content item 122 was obtained, e.g., because the user posted the content item 122 to the online social networking system 100. The user information 216 includes an image 204B, name 206B, job description 208B, and influence score 210B of the user. (Herein after, influence scores may be denoted collectively or individually as the “influence score 210”).

The content pane 214 as illustrated further reflects a member activity 218, as illustrated that “Jane Roe likes this” content item 122. The content pane 214 further provides for engagement with the content item 122 by the member. For instance, the member may click on the article of the content item 122 to display the article, may select the “like”, “comment”, or “share” icons 220, and so forth.

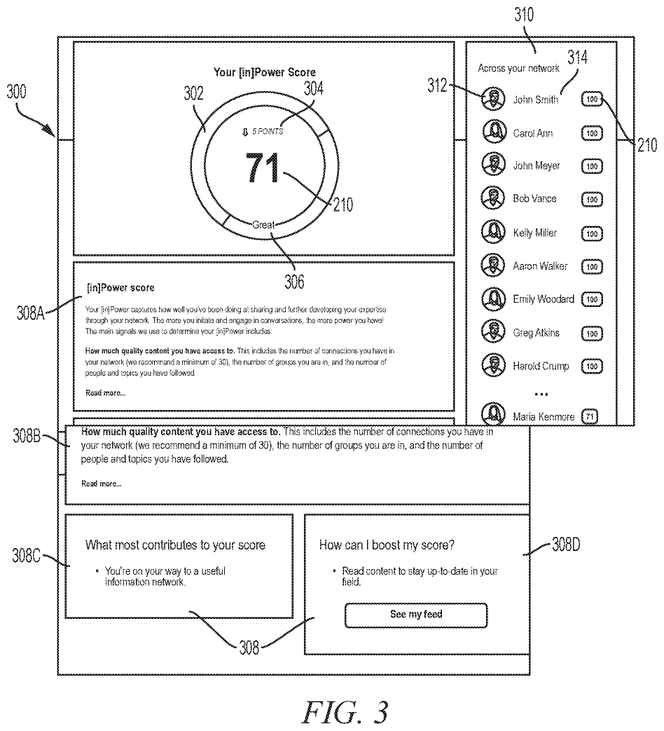

FIG. 3 is an influence score screen 300, in an example embodiment. The influence score screen 300 may be accessible from the user interface screen 200. For instance, where the influence score 210 is or is displayed as an icon, a user may select the influence score 210, e.g., by clicking, tapping, or otherwise engaging with the influence score 210 on the user interface screen 200. Additionally or alternatively, a user may access or be taken to the influence score screen 300 according to any desired mechanism, e.g., by being prompted to go to the screen for an explanation of the user's influence score, a demonstration of how an influence score may prospectively be calculated or refined, or an explanation of how the influence score may be improved.

In the illustrated example, the influence score screen 300 includes the influence score 210 of the associated member, a graphic representation 302 of the influence score 210, a change in influence score 304, and a verbal indication 306 of the influence score 210. The graphic representation 302, as illustrated, is a gauge chart that having a percentage fill that corresponds to the influence score 210, though it is noted that any suitable chart or graphic representation of the influence score 210 may be utilized. The change in influence score 304 represents an amount that the influence score 210 has increased or decreased over a predetermined period, e.g., a day, week, month, quarter, or year. The change in influence score 304 may include an icon, coloring, or any mechanism for indicating that the change in influence score 210 is positive or negative.

The verbal indication 306 may provide a descriptor of the relative quality of the influence score 210. For instance, an influence score 210 of 85-100 points may be “Excellent”, an influence score 210 of 70-84 points may be “Great”, an influence score 210 of 50-69 points may be “Good”, an influence score 210 of 25-49 points may be “Fair”, and an influence score of 0-24 points may be “Poor”. In various examples, a verbal indication 306 may not be presented at all if the verbal indication 306 is “Fair” or “Poor”. The above example is for illustrative purposes and it is noted an emphasized that the verbal indication 306 may be implemented according to any language or terminology and according to any point ranges and other polices desired.

The influence score screen 300 further includes influence score description windows 308. For instance, an influence score description window 308A may describes for the member what the influence score 210 means a general description of how the influence score 210 was calculated. A second influence score description window 308B describes one of the factors that is utilized in calculating the influence score 210, as illustrated the amount of quality content the member has access to. A third influence score description window 308C describes a factor that most contributes to the influence score 210, which will be illustrated herein in detail. A fourth influence score description window 308D describes how the member may improve their influence score 210, according to methods described in detail herein. It is noted and emphasized that the influence score description windows 308 described herein are provided for example, and that more or fewer influence score description windows 308 may be displayed. Moreover, the influence score description windows 308 may display any information related to the influence score 210 as may appropriate or desired by the member or the online social networking system 100 policies.

The influence score screen 300 as illustrated further includes a connections window 310 showing members of the online social networking system 100 who are part of the subject member's social network, as stored in the social graph database 112. As illustrated, each member in the connections window 310 includes a name 312, an associated image 314, and an influence score 210. As illustrated, the connections window 310 shows members who have the highest influence scores 210 among the subject member's social graph. However, it is noted and emphasized that any criteria may be applied to select members for the connections window 310.

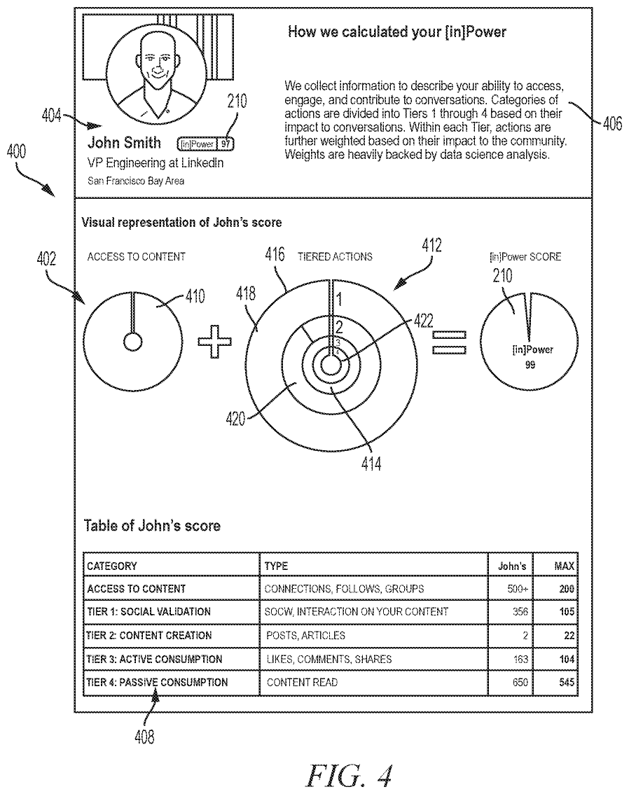

FIG. 4 is an influence score calculation screen 400, in an example embodiment. The influence score calculation screen 400 includes various descriptions of how the influence score 210 was calculated. The influence score calculation screen 400 includes a graphical illustration 402 of how the influence score module 108 calculated the influence score 210, a member depiction 404 of the member associated with the influence score, a written description 406 of how the influence score 210 was calculated, and a details section 408 of how the influence score 210 was calculated. In various examples, the influence score calculation screen 400 may be accessed from directly from the user interface screen 200 by selecting the influence score 210 or related icon or from the influence score screen 300.

As illustrated, the computation of the influence score 210 involves two categories of factors: access to content 410 and activities 412. Access to content 410 is illustrated as a gauge and, in the example calculation of the influence score 210, accounts for a maximum of thirty-five (35) points. An access to content score may calculated based on information from the social graph database 112 by summing or otherwise combining points on the member's social graph, including the total number connections in the member's social graph, the number of other members or entities (e.g., companies, organizations, news or other content sources, etc.) that the member follows, and groups that the member is part of.

The access to content score may be calculated as a fraction of a predetermined maximum number of social graph points of the member. In the illustrated example, the predetermined maximum is two hundred (200). As such, Where a member has two hundred (200) points or more, then the member receives the full access to content score of thirty-five (35). If the member has fewer than the predetermined maximum then the member receives an access to content score corresponding to a percentage of the maximum number of points the member does have. Thus, for instance, if the member had one hundred twenty points the member would receive an access to content score of 35*120/200=21. Fractions may be left as fractions or decimal points or may be rounded up, down, or to the nearest integer. In the illustrated example, the member has a combined total of more than five hundred (500) points and therefore receives an access to content score of thirty-five (35). Alternatively, the access to content score may be calculated according to the type of decaying curve utilized for tiers of the activities 412, described in detail below.

Activities 412 are illustrated in a tiered gauge 414, with each tier relating to certain types of activities 118 stored in the activity database 114. In the illustrated example, the tiers include a social validation tier 416, a content creation tier 418, an active consumption tier 420, and a passive consumption tier 422. The social validation tier 416 provides a social validation score relating to the number of social interactions by others with content posted by the member, e.g., likes, comments, shares, etc. The content creation tier 418 provides a content creation score relating to the generation of content by the member, e.g., by posting content to the online social networking system 100, sharing content, etc. The active consumption tier 420 provides an active consumptions core relating to social interactions by the member with content posted by others to the online social networking system 100, e.g., likes, comments, shares, etc. The passive consumption tier 422 provides a passive consumption score relating to content consumed on the online social networking system 100, e.g., by reading through a teed, reading articles linked to on third party web sites, reading messages sent to the member by other members, etc.

The social validation score, the content creation score, the active consumption score, and the passive consumption score may collectively be referred to as the activity component scores and may be combined to create an activity score, e.g., by adding the activity component scores together. In various examples, some of the activity component scores may be determined on the basis of decaying functions that weight initial activities more heavily than subsequent activities in order to arrive at the particular activity component score. In an example, all of the activity component scores are calculated according to decaying functions.

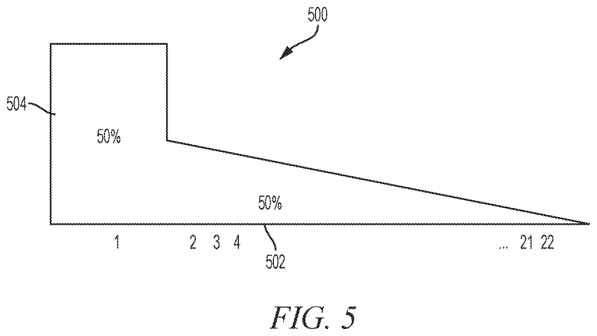

FIG. 5 is a graphical illustration of a decaying function 500, in an illustrative example. The decaying function 500 is presented specifically with respect to the content creation tier 418 and the determination of the content creation score. The x-axis 502 corresponds to a number of activities taken by the member to create or otherwise contribute content to the online social networking system 100 over a predetermined time, e.g., a three month period. The y-axis 504 corresponds to a number of points each activity contributes to the total content creation score.

It has been empirically determined that the initial activities a member performs across the activity component scores are relatively more significant to the relative influence status of the member than subsequent activities within each activity component. As such, in various examples, the initial activities within an activity component score account for half of the total points contributing to the activity component.

In the illustrated example, the first activity to contribute content to the online social networking system is worth ten (10) of the twenty (20) total possible points for the content creation score. Thus, for instance, if the member has contributed a single link to an article on a third-party website to the online social networking system 100 in the last three months, the member's content creation score would be ten (10). The remaining points are distributed across the remaining activities up to a predetermined maximum number of activities that may contribute to the content creation score. As illustrated, the remaining points are linearly distributed, with each of the twenty-one (1) activities up to the predetermined maximum of twenty-two (22) activities accounting for 10/21=0.476 points. Thus, if a member had three (3) actions for content creation, the member's content creation score would be 10+2*0.476=10.952, which rounds to eleven (11).

The predetermined maximum for each activity component score may be empirically determined based on activities by all members of the online social networking system 100. In an illustrative example, the predetermined maximum is based on the number of corresponding activities by the ninety-fifth percentile of members. Thus, in the illustrative example of FIG. 5, for the content creation score the ninety-fifth percentile of members perform twenty-two (22) qualifying activities 118 over the established period, i.e., they contribute content twenty-two (22) times every three (3) months. Any of a variety of percentiles may be selected, or the predetermined maximum may be set according to any desired mechanism, e.g., a selected number of activities not based on actual member activities 118.

In alternative examples, rather than being based on a linearly decaying function, the decaying function 500 may decay exponentially, with the relatively, earlier activities counting for more than the last activities. Thus, for instance, in the above example the second activity may be worth 1.0 point while the twenty-second activity may be worth 0.1 points.

The principles disclosed with respect to the content contribution tier 418 may be applied to the generation of all of the activity component scores. In various examples, the social validation score may be out of twenty-five (25) total points while the active consumption score and the passive consumption score may each be out of ten (10) points. Combined, the maximum possible activity score may thus be sixty-five (65). In the illustrative example, the predetermined maximum activities, e.g., the qualifying activities 118, for the social validation tier 416 is two hundred (200), the predetermined maximum activities for the active consumption tier 420 is 104, and the predetermined maximum activities for the passive consumption tier 422 is 545. It is noted and emphasized that each of those predetermined maximum level is determined empirically based on the qualifying activities of the ninety-fifth percentile of members of the online social networking system.

It is further noted that the predetermined maximum may be updated as the activities 118 of the members change over time. Thus, the predetermined maximum for one or more of the tiers 416, 418, 420, 422 may increase or decrease if members at the ninety-fifth percentile of activities within a given tier 416, 418, 420, 422 do more or fewer such activities. For instance, if members at the ninety-fifth percentile over time begin contributing an average of twenty-six (26) content items 122 per three-month period then the predetermined maximum for the content creation tier 418 would increase to twenty-six (26) and the number of points per activity would fall to 10/(26−1)=0.4.

The activity score may then be combined, e.g., added to, the access content score to generate the influence score 210. The user interface thus provided by the user interface screen 200, the influence score screen 300, and the influence score calculation screen 400 thus provide the scope for members to fluidly and interactively identify their own influence score 210, compare that influence score 210 to those of other members, and understand how their own influence score 210 may be increased. By facilitating the increase of a member's influence score 210, the influence score module 108 and the user interface provided thereby may encourage a more enriching experience by the member with the online social networking system 100 as well as raising the profile of the member within the online social networking system 100, Raising the profile of the member may accrue to the advantage of the member in the form of increased opportunities to engage with other members of the online social networking system 100.

The user interface provided by the influence score module 108 may further advantageously allow members to see how other members have acted to establish their own influence scores 210, subject to privacy policies and requirements. Thus, for instance, a member may click on the influence score of another member to navigate through the user interface to see the kinds of activities 118 engages in to accrue their own influence score 210. Privacy policies set by the subject member or the online social networking system 100 generally may establish what information may be viewable by other members in the context of the calculation of that member's influence score 210, but to the extent that such information is available the user interface provided may allow other members to understand the activities 118 or types of activities that the member engages in to produce their influence score.

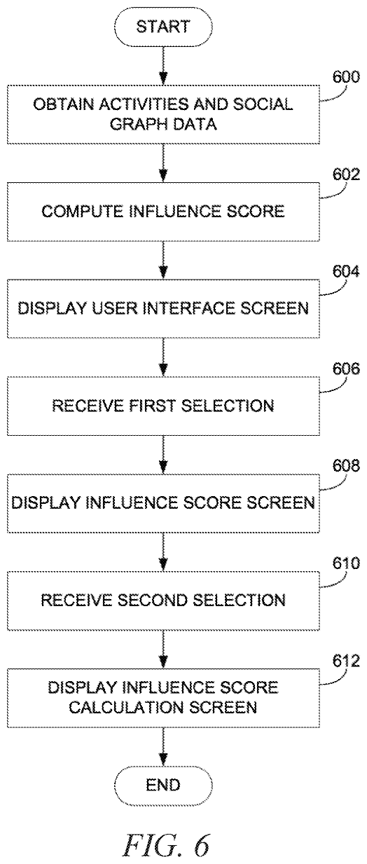

FIG. 6 is a flowchart for generating a user interface for user influence, in an example embodiment.

At 600, activities of members of an online social networking system and social graph data of the members are obtained from a database of an online social networking system.

At 602, an influence score is computed for one of the members by combing an access to content score with an activities score, the access to content score based on a number of social graph connections of the one of the members with other members and the activities score based on a number of activities by the member with content items posted to the online social networking system by other members and activities by other members with content items posted by the member. In an example, the access to content score is based on a number of social graph connections of the member in relation to a predetermined maximum number of social graph connections.

In an example, the activities score is based on factor scores, each of the factor scores associated with one of a plurality of factors, each of the plurality of factors associated with some of the activities, each of the factor scores based on a number of associated some of the activities in comparison to an associated predetermined maximum number of activities. In an example, the plurality of factors include: social validation activities.

At 604, a user interface is caused to display a user interface screen to display the influence score in relation to the member.

At 606, a first selection related to the influence score is received as input from the user interface screen.

At 608, causing, via the network interface, the network interface to display the influence score screen, the influence score screen displaying the influence score and at least one of: a graphic representation of the influence score; a change in the influence score over time; and a verbal indication of the influence score. In an example, the influence score screen further includes an influence score description window, configured to display at least one of: a description of how the influence score was calculated; factors utilized in computing the influence score; a factor that most contributes to the influence score; and how the member may improve the influence score.

At 610, a second selection related to the influence score is received.

At 612, the user interface is caused to display an influence score calculation screen including graphical illustrations of the access to content score and the activities score. In an example, the influence score calculation screen includes a details section showing the number of social graph connections of the access to content score and the number of activities associated with each of the plurality of factors.

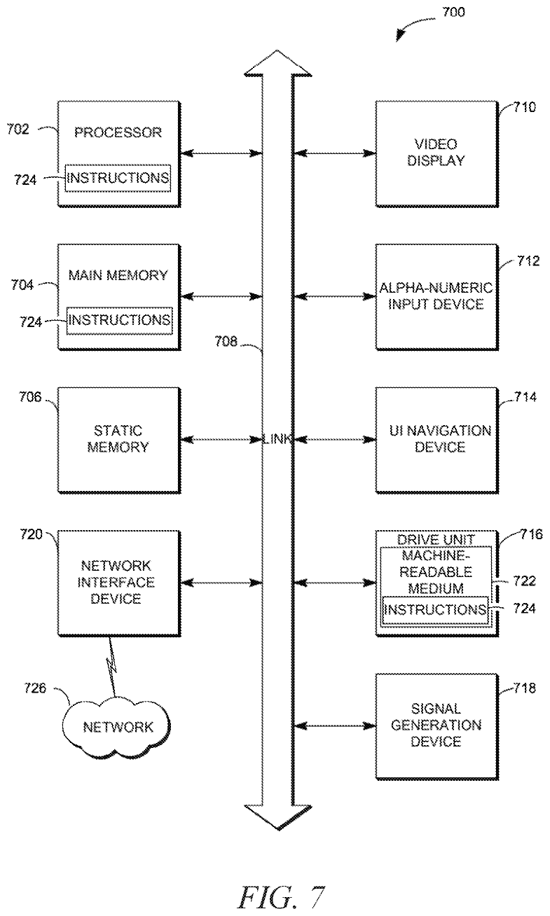

FIG. 7 is a block diagram illustrating components of a machine 700, according to some example examples, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software) for causing the machine 700 to perform any one or more of the methodologies discussed herein may be executed. In alternative examples, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify activities to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 (e.g., software) embodying any one or more of the methodologies or functions described herein. The instructions 724 may also reside, completely or at least partially, within the main memory 704, within the processor 702. (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing or carrying instructions (e.g., software) for execution by a machine 700), such that the instructions, when executed by one or more processors of the machine processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium including a signal or a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically; in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g.; programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the tetras “a” or “an” are herein used, as is common in patent documents, to include one or more than one instance. Finally, as used herein, the conjunction “or” refers to a non-exclusive “or,” unless specifically stated otherwise.

What is claimed is:

1. A processor-implemented method, comprising:
obtaining, from a database of an online social networking system, activities of members of the online social networking system and social graph data of the members;
computing, for one of the members, an influence score for one of the members by combing an access to content score with an activities score, the access to content score based on a number of social graph connections of the one of the members with other members and the activities score based on a number of activities by the member with content items posted to the online social networking system by other members and activities by other members with content items posted by the member;
causing, via a network interface, a user interface to display a user interface screen to display the influence score in relation to the member;
receiving, via the networking interface, a selection related to the influence score;
causing, via the network interface, in response to the selection, the user interface to display an influence score calculation screen including graphical illustrations of the access to content score and the activities score.

2. The method of claim 1, wherein receiving the selection related to the influence score is a second selection related to the influence score from an influence score screen, and further comprising:
receiving, via the network interface, a first selection related to the influence score input from the user interface screen;
causing, via the network interface, the user interface to display the influence score screen, the influence score screen displaying the influence score and at least one of: a graphic representation of the influence score; a change in the influence score over time; and a verbal indication of the influence score.

3. The method of claim 2, wherein the influence score screen further includes an influence score description window, configured to display at least one of: a description of how the influence score was calculated; factors utilized in computing the influence score; a factor that most contributes to the influence score; and how the member may improve the influence score.

4. The method of claim 1, wherein the access to content score is based on a number of social graph connections of the member in relation to a predetermined maximum number of social graph connections.

5. The method of claim 4, wherein the activities score is based on factor scores, each of the factor scores associated with one of a plurality of factors, each of the plurality of factors associated with some of the activities, each of the factor scores based on a number of associated some of the activities in comparison to an associated predetermined maximum number of activities

6. The method of claim 5, wherein the plurality of factors include: social validation activities; content creation activities; active consumption activities; and passive consumption activities.

7. The method of claim 6, wherein the influence score calculation screen includes a details section showing the number of social graph connections of the access to content score and the number of activities associated with each of the plurality of factors.

8. A computer readable medium comprising instructions which, when performed by a processor, cause the processor to perform operations comprising:
obtain, from a database of an online social networking system, activities of members of the online social networking system and social graph data of the members;
compute, for one of the members, an influence score for one of the members by combing an access to content score with an activities score, the access to content score based on a number of social graph connections of the one of the members with other members and the activities score based on a number of activities by the member with content items posted to the online social networking system by other members and activities by other members with content items posted by the member;
cause, via a network interface, a user interface to display a user interface screen to display the influence score in relation to the member;
receive, via the networking interface, a selection related to the influence score;
cause, via the network interface, in response to the selection, the user interface to display an influence score calculation screen including graphical illustrations of the access to content score and the activities score.

9. The computer readable medium of claim 8, wherein receiving the selection related to the influence score is a second selection related to the influence score from an influence score screen, and further comprising instructions that cause the processor to:
receive, via the network interface, a first selection related to the influence score input from the user interface screen;
cause, via the network interface, the user interface to display the influence score screen, the influence score screen displaying the influence score and at least one of: a graphic representation of the influence score; a change in the influence score over time; and a verbal indication of the influence score.

10. The computer readable medium of claim 9, wherein the influence score screen further includes an influence score description window, configured to display at least one of: a description of how the influence score was calculated; factors utilized in computing the influence score; a factor that most contributes to the influence score; and how the member may improve the influence score.

11. The computer readable medium of claim 8, wherein the access to content score is based on a number of social graph connections of the member in relation to a predetermined maximum number of social graph connections.

12. The computer readable medium of claim 11, wherein the activities score is based on factor scores, each of the factor scores associated with one of a plurality of factors, each of the plurality of factors associated with some of the activities, each of the factor scores based on a number of associated some of the activities in comparison to an associated predetermined maximum number of activities

13. The computer readable medium of claim 12, wherein the plurality of factors include: social validation activities; content creation activities; active consumption activities; and passive consumption activities.

14. The computer readable medium of claim 13, wherein the influence score calculation screen includes a details section showing the number of social graph connections of the access to content score and the number of activities associated with each of the plurality of factors.

15. A system, comprising:
a computer readable medium comprising instructions which, when performed by a processor, cause the processor to perform operations comprising:
obtain, from a database of an online social networking system, activities of members of the online social networking system and social graph data of the members;
compute, for one of the members; an influence score for one of the members by combing an access to content score with an activities score, the access to content score based on a number of social graph connections of the one of the members with other members and the activities score based on a number of activities by the member with content items posted to the online social networking system by other members and activities by other members with content items posted by the member;
cause, via a network interface, a user interface to display a user interface screen to display the influence score in relation to the member;
receive, via the networking interface, a selection related to the influence score;
cause, via the network interface, in response to the selection, the user interface to display an influence score calculation screen including graphical illustrations of the access to content score and the activities score.

16. The system of claim 15, wherein receiving the selection related to the influence score is a second selection related to the influence score from an influence score screen, and further comprising instructions that cause the processor to:
receive, via the network interface, a first selection related to the influence score input from the user interface screen;
cause, via the network interface, the user interface to display the influence score screen, the influence score screen displaying the influence score and at least one of: a graphic representation of the influence score; a change in the influence score over time; and a verbal indication of the influence score.

17. The system of claim 16, wherein the influence score screen further includes an influence score description window, configured to display at least one of: a description of how the influence score was calculated; factors utilized in computing the influence score; a factor that most contributes to the influence score; and how the member may improve the influence score.

18. The system of claim 15, wherein the access to content score is based on a number of social graph connections of the member in relation to a predetermined maximum number of social graph connections.

19. The system of claim 18, wherein the activities score is based on factor scores, each of the factor scores associated with one of a plurality of factors, each of the plurality of factors associated with some of the activities, each of the factor scores based on a number of associated some of the activities in comparison to an associated predetermined maximum number of activities

20. The system of claim 19, wherein the plurality of factors include: social validation activities; content creation activities; active consumption activities; and passive consumption activities.
